(19) United States
(12) Patent Application Publication
(10) Pub. No.: US 2009/0218189 A1
(43) Pub. Date: Sep. 3, 2009

(54) Friction Element

(75) Inventors: Norbert Bastel, Ober-Rheinhausen (DE); Stefan Ueberle, Heidelberg (DE)

Correspondence Address: MILLER, MATTHIAS & HULL, ONE NORTH FRANKLIN STREET, SUITE 2350, CHICAGO, IL, 60606, US

(73) Assignee: BORGWARNER, INC., Auburn Hills, MI (US)

(21) Appl. No.: 12/158,910

(22) PCT Filed: Jan. 5, 2007
(86) PCT No.: PCT/EP2007/000054

§ 371 Date: Oct. 17, 2008

(30) Foreign Application Priority Data
Jan. 20, 2006 (DE) 10 2006 003 088.5

(51) Int. Cl. F16D 13/64

(52) U.S. Cl. 192/200

(57) ABSTRACT

The invention relates to a friction element, in particular a clutch disk or brake disk, having: a disk-shaped lining carrier which supports or has at least one friction lining and has a central opening, and at least one hub part with a central receiving opening, which is formed with a hub toothing, for receiving a shaft which is formed with a shaft toothing, wherein the hub part and the lining carrier are arranged adjacent to one another so as to rotate together with the shaft, and wherein the central opening of the lining carrier is embodied as a shaft receiving opening with a lining carrier toothing for engaging into the shaft toothing of the shaft.

The invention relates to a friction element, in particular a clutch disk or brake disk, as per the precharacterizing features of patent claim 1.

A friction element is conventionally composed of a lining carrier, which for example forms a brake disk and which is of disk-shaped design and which carries or has at least one friction surface, with the lining carrier having a central opening through which a shaft is guided. A friction element also has at least one hub part with a central receiving opening for receiving the shaft. The receiving opening in the hub part is formed with a hub toothing which is coordinated with a shaft toothing on the outer periphery of the shaft. In operation, the hub part is seated on the shaft in such a way that the hub toothing and the shaft toothing engage into one another for force transmission and for common rotation. The hub part and the lining carrier are arranged adjacent to one another for common rotation about the shaft and are conventionally rotationally fixedly connected to one another.

EP 0 372 118 B1 describes a friction element of said type, with a lining carrier which is constructed as a disk being arranged between two hub parts. Spring sleeves which serve for shear force transmission and torque transmission lead through the arrangement, composed of the two hub parts and the lining carrier, so as to be fixed without play in a direction axially parallel to the shaft. Fastening elements extend through the spring sleeves, which fastening elements fix the spring sleeves. The spring sleeves are embodied as assembly sleeves which can be flanged and which, in the flanged state, hold the lining carrier and the hub parts together axially. The spring sleeves are formed by a cylindrical sleeve body which is slotted in the longitudinal direction in order to provide a degree of elasticity for compensating shocks or an unbalance.

A receiving opening of the lining carrier for leading through a shaft which is to be braked on demand has a larger diameter than receiving openings formed in the hub parts. Contact between the lining carrier and shaft is prevented in this way. A transmission of force or transmission of torque between the lining carrier and the shaft takes place exclusively indirectly via the spring sleeves with the fastening elements and the hub parts.

In an arrangement of said type, in order to transmit a certain torque, the hub parts must be correspondingly dimensioned in the axial direction. The fastening elements must also be of suitably large dimensions and provided in sufficient numbers to permit fault-free torque transmission between the hub parts and the lining carrier. The greater the torque to be transmitted, the larger the arrangement must be in the axial direction in order that the hub parts have sufficient stability. Furthermore, with increasing torque to be transmitted, the radial extent must also increase in order to permit a sufficient number and dimensioning of the fastening elements. It is alternatively or additionally possible to use higher-grade materials to form the hub parts and the fastening elements in order to obtain greater torques to be transmitted.

It is the object of the invention to propose a friction element with an alternative design, which preferably permits a smaller structural size in the axial and/or radial direction and/or the use of less high-grade materials to be able to transmit a certain torque.

Said object is achieved by means of a friction element, in particular a clutch disk or brake disk, having the features of patent claim 1.

Advantageous embodiments are the subject matter of the dependent claims.

Accordingly preferable is a friction element, in particular clutch disk or brake disk, having a disk-shaped lining carrier which carries or has at least one friction lining and which has a central opening, and at least one hub part having a central receiving opening, which is formed with a hub toothing, for receiving a shaft which is formed with a shaft toothing. Here, the hub part and the lining carrier are arranged adjacent to one another for common rotation with the shaft, with the central opening of the lining carrier being formed as a shaft receiving opening with a lining carrier toothing for engaging into the shaft toothing of the shaft.

A toothing geometry of the lining carrier toothing and of the hub toothing is preferably identical or identical to one another within a predefined tolerance, so as to permit a uniform transmission of torque between the shaft on the one hand and the lining carrier and the hub part on the other hand. An inner diameter of the shaft receiving opening of the lining carrier is preferably smaller than, equal to or equal within a tolerance range to an inner diameter of the receiving opening of the hub part, such that a transmission of torque between the lining carrier and the shaft takes place between these directly or at least directly to a desired extent. In this way, a torque can be entirely or partially transmitted in a direct manner between the shaft and the lining carrier.

The hub part is designed with regard to material and/or dimensions so as to laterally support the lining carrier without a transmission of torque between the lining carrier and the shaft via the hub part, such that the hub part is to be dimensioned, or selected with regard to its material, merely as a supporting element.

According to a further or combined embodiment, the lining carrier and the hub part are fixedly connected to one another at a distance from the central shaft receiving opening and from the receiving opening. Here, it is possible to resort to proven fastening methods. Depending on the dimensioning, a transmission of torque from the shaft via the hub part to the lining carrier takes place here, such that the lining carrier toothing is relieved of load and a thin or correspondingly less high-grade material of the lining carrier can be used.

Here, the connection of the lining of the lining carrier and of the hub part is formed by means of at least one fastening element which is guided through said lining carrier and hub part axially parallel to the shaft receiving opening and receiving opening, in particular in the form of a rivet connection. A central section of the lining carrier is preferably held between two such hub parts. This offers improved guidance and improved hold for the lining carrier and, in the case of a fixed connection by means of fastening elements, an improved transmission of torque also via the hub parts to the outer peripheral region of the lining carrier.

Also preferable is a friction element of said type in which the lining carrier has at least one fastening opening for leading through a fastening element, with the fastening openings having, in an in particular radial direction, a greater diameter than an outer diameter of the fastening elements, so as to offer unbalance or shock compensation and to thereby permit a longer service life, with it being possible to resort to arrangements which are known per se.

In particular, a lining carrier in the form of a carrier plate should also have a lining carrier toothing identical to a hub toothing. In this way, it is possible for a greater overall torque to be transmitted for the same size of toothing. If the torque to be transmitted remains constant and a higher torque is not required, it is alternatively or additionally possible to use a less high-grade and therefore cheaper material for the hub. A further advantage is that the torque transmitted by the toothed lining carrier need not be transmitted entirely by the fastening elements, in the form in particular of the rivet connections.

In particular, a friction element having a clamping sleeve connection as per EP 0 372 118 B1 is also improved by means of an additional toothing in the form of the lining carrier toothing which engages into the shaft toothing. The improvement is based on the fact that the additional toothing makes it possible to transmit greater torques without more axial installation space being required. The torque transmitted by the additional toothing advantageously need not be supported, or need not be supported entirely, by the fastening elements embodied as rivets. The toothing geometry of the two hub parts and of the lining carrier is expediently identical, thereby enabling assembly in the correct position.

One exemplary embodiment is explained in more detail below on the basis of the drawing, in which:

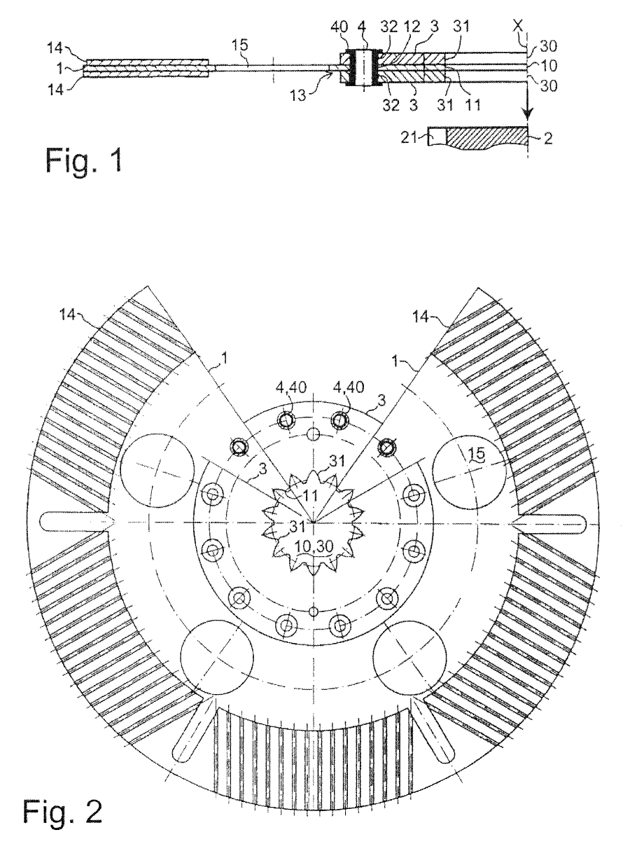

FIG. 1 shows a section view through a detail of a friction element in a side view, and

FIG. 2 shows a partially sectioned plan view of a friction element of said type.

As can be seen from FIG. 1 and FIG. 2, a friction element, in particular a friction element for forming a clutch disk or brake disk, has a central lining carrier 1 which is of substantially disk-shaped design. The lining carrier 1 preferably has a circular outer periphery, though this is not imperative. A central shaft receiving opening 10 is formed in the lining carrier 1 so as to extend through the latter. The shaft receiving opening 10 serves for axially pushing the lining carrier 1 onto a shaft 2. The shaft 2 has, at its outer periphery, a non-circular contour, preferably projections in the form of one or more teeth. In this way, a shaft toothing 21 formed from at least one projection or tooth is formed on the outer periphery of the shaft. The contour of the inner periphery of the shaft receiving opening 10 of the lining carrier 1 is matched to the outer contour of the shaft 2, such that a rotation of the shaft 2 is positively transmitted to the lining carrier 1 or, conversely, a rotation of the lining carrier 1 is transmitted to the shaft 2. Changes in the rotation in the form of positive and negative accelerations in the form of torques are correspondingly also transmitted from the lining carrier 1 to the shaft 2 or, in the opposite direction, from the shaft 2 to the lining carrier 1. The shaft receiving opening of the lining carrier 1 is preferably designed with regard to its contour not only so as to match but also so as to be mirror-symmetrical with respect to the outer contour of the shaft 2, and has a corresponding lining carrier toothing 11.

The friction element also additionally has one or two hub parts 3 which, in the particularly preferred embodiment illustrated, are arranged laterally on both sides of a central section of the lining carrier 1. The hub parts have in each case one central receiving opening 30 for leading through the shaft 2. The receiving openings 30 of the hub parts 3 preferably have a contour corresponding to or mirror-symmetrical with respect to the outer contour of the shaft 2 in order to transmit torques from the shaft to the hub parts 3 or, conversely, from the hub parts 3 to the shaft 2. Correspondingly, one or both of the hub parts 3 are formed with a hub toothing 31 which, when placed on the shaft 2, engages into the shaft toothing 21.

According to one particularly simple embodiment, it is possible for the hub parts 3 to be formed merely as lateral support elements and not to be fixedly connected to the lining carrier 1. An embodiment is preferable, however, in which one or both hub parts 3 of said type are fixedly connected to the lining carrier 1 by means of one or preferably more fastening elements. As fastening elements 4, use is preferably made of rivets or sleeves with a flanged sleeve edge 40, which lead through corresponding fastening openings 12, 32 in the lining carrier 1 and in the hub parts 3. Here, the fastening openings 12, 32 are preferably arranged axially parallel to a central axis X of the shaft 2 and of the shaft receiving opening 10 and of the receiving openings 30, and at a distance from the shaft receiving opening 10 and the receiving openings 30. In the radial direction, the hub parts 3 preferably extend only a short distance, enough to provide sufficient hold for the fastening element 4, beyond the fastening openings 32.

The lining carrier 1 can have recesses or passage openings 15 between its central section 13 and an outer section on which friction linings 14 are formed or fastened, which recesses or passage openings 15 preferably serve to save material. Said passage openings 15 are preferably arranged in a region radially behind the laterally adjacent hub parts 3.

Alternative embodiments can also be of advantageous design, with the lining carrier 1 with the shaft receiving opening 10 and the lining carrier toothing 11 always being implemented as an essential element. Correspondingly, it is possible in particular to carry out modifications with regard to one or more of the hub parts 3 and their material selection and/or material thickness in the axial direction. It is also possible for the material selection and the material thickness in the axial direction of the lining carrier 1 to be adapted depending on the torques to be transmitted. A fixed fastening of the lining carrier 1 and of the hub part(s) 3 by means of fastening elements is advantageous in embodiments in particular in which a partial torque transmission assisted by means of the hub part(s) 3 takes place. Also possible is an implementation of alternative embodiments using fastening elements 4 in the form of slotted sleeves as per, for example, EP 0 372 118 B1, with non-identical toothings of the lining carrier toothing 11 and of the hub toothing 31 being formed in embodiments of said type if appropriate. However, the shaft receiving opening 10 of the lining carrier 1 and the receiving openings 30 of the hub parts 3 advantageously, but need not imperatively, have an identical inner periphery.

### List of Reference Symbols

1 Lining carrier
10 Shaft receiving opening
11 Lining carrier toothing
12 Fastening opening
13 Central section of 1
14 Friction lining
15 Passage opening
2 Shaft
21 Shaft toothing
3 Hub part
30 Receiving opening in 3
31 Hub toothing
32 Fastening opening
4 Fastening element
40 Flanged sleeve edge
X Axis of the shaft

1. A friction element, in particular a clutch disk or brake disk, comprising:
a disk-shaped lining carrier which carries or has at least one friction lining and which has a central opening,
at least one hub part having a central receiving opening, which is formed with a hub toothing, for receiving a shaft which is formed with a shaft toothing, with the hub part and the lining carrier being arranged adjacent to one another for common rotation with the shaft, and
wherein the central opening of the lining carrier is formed as a shaft receiving opening with a lining carrier toothing for engaging into the shaft toothing of the shaft.

2. The friction element as claimed in claim 1, in which a toothing geometry of the lining carrier toothing and of the hub toothing is identical or identical to one another within a predefined tolerance.

3. The friction element as claimed in claim 1, in which an inner diameter of the shaft receiving opening of the lining carrier is formed so as to be smaller than, equal to or equal within a tolerance range to an inner diameter of the receiving opening of the hub part.

4. The friction element as claimed in claim 1, in which the hub part is designed with regard to material and/or dimensions so as to laterally support the lining carrier without a transmission of torque between the lining carrier and the shaft via the hub part.

5. The friction element as claimed in claim 1, in which the lining carrier and the hub part are fixedly connected to one another at a distance from the central shaft receiving opening and from the receiving opening.

6. The friction element as claimed in claim 5, in which the connection of the lining carrier and of the hub part is formed by means of at least one fastening element which is guided through said lining carrier and hub part axially parallel to the shaft receiving opening and receiving opening, in particular in the form of a rivet connection.

7. The friction element as claimed in claim 1, having a further hub part of said type, with a central section of the lining carrier being held between the two hub parts.

8. The friction element as claimed in claim 7, in which the lining carrier has at least one fastening opening for leading through a fastening element, with the fastening openings having, in an in particular radial direction, a greater diameter than an outer diameter of the fastening elements.
